(19) United States
(12) Patent Application Publication
(10) Pub. No.: US 2012/0013929 A1
(43) Pub. Date: Jan. 19, 2012

(54) IMAGE FORMING APPARATUS

(75) Inventor: Mitsuhiko OTAKI, Kanagawa (JP)

(73) Assignees: Toshiba Tec Kabushiki Kaisha, Tokyo (JP); Kabushiki Kaisha Toshiba, Tokyo (JP)

(21) Appl. No.: 13/180,362

(22) Filed: Jul. 11, 2011

Related U.S. Application Data
(60) Provisional application No. 61/363,979, filed on Jul. 13, 2010.

(51) Int. Cl. G06F 3/12

(52) U.S. Cl. 358/1.13

(57) ABSTRACT

According to one embodiment, there is provided a complex-type image forming apparatus capable of achieving both convenience and power saving by registering necessary functions in advance for each user, reading the registered function when an individual user is authenticated, and feeding power to a device corresponding to the registered function.

### CROSS-REFERENCE TO RELATED APPLICATIONS

This application is based upon and claims benefit of priority from U.S. Provisional Application No. 61/363979 filed on Jul. 13, 2010, the entire contents of which are incorporated herein by reference.

### FIELD

Embodiments described herein relate generally to an image forming apparatus which is a multi function peripheral with a plurality of functions such as a copy function, a scan function, a FAX function, and a printer function.

### BACKGROUND

In recent years, complex-type image forming apparatuses with a copy function, a scan function, a FAX function, and a printer function have come into wide use. As for such complex-type image forming apparatuses, there is known a technique for power saving by operating only a function that a user selects by a main control unit when the user operates an operation panel unit, through which an input operation is selectively possible for all functions, to select and input a function operable within a setting time from a power start-up time.

That is, in the complex-type image forming apparatus with the copy function, the scan function, the FAX function, the printer function, and the like, a function with the longest time taken from the power start-up time to a time at which the function is operable is, for example, the printer function. In order to operate the printer function, it takes some time to increase a heater temperature for fixing toner. When a function, such as the FAX function, other than the printer function is selected within the temperature increase time, only the FAX function is operated. According to this technique, convenience is improved since operation of a function whose start-up time is short becomes possible within a standby time of the copy function, the scan function, the FAX function, the printer function, or the like from the power start-up time. However, when the standby time ends, the power-saving effect becomes low in that the power is supplied to all the functions.

Further, there is known a technique for operating only an operation unit at a power start-up time and supplying no power to all the functions of the copy function, the scan function, the FAX function, the printer function, and the like. That is, only the operation unit is operated at the power start-up time and the state of the operation unit is transitioned to a function selection waiting state. When a user selects a function, power is supplied only to a unit associated with the selected function.

### BRIEF DESCRIPTION OF THE DRAWINGS

FIG. 1 is a perspective view illustrating an image forming apparatus.

FIG. 2 is a block diagram of the image forming apparatus.

FIG. 3 is a flowchart illustrating processes.

### DETAILED DESCRIPTION

In the above-mentioned techniques, a new operation is necessary at a recovery time from a power-saving mode and it takes some time for a user to start using a desired function immediately. For this reason, the above-mentioned techniques have a problem that both convenience and power saving may not be compatible. According to one embodiment, an image forming apparatus, which is a complex-type image forming apparatus with a plurality of functions, includes: a power source unit; an operation unit that is connected to the power source unit; a main controller that is connected to the power source unit via a power feeding relay turned on or off by a signal from the operation unit; function controllers that are installed for the plurality of functions, respectively; power feeding relays that are connected between the controller and the power source unit for the functions, respectively, and are turned on or off by the signal from the main controller; an individual authentication control unit that reads user registration data, in which the function selected among the plurality of functions is registered for a user of the image forming apparatus, and is installed in the operation unit. Based on the user registration data, the main controller transmits the signal for turning on the power feeding relay of the function controller for the registered function.

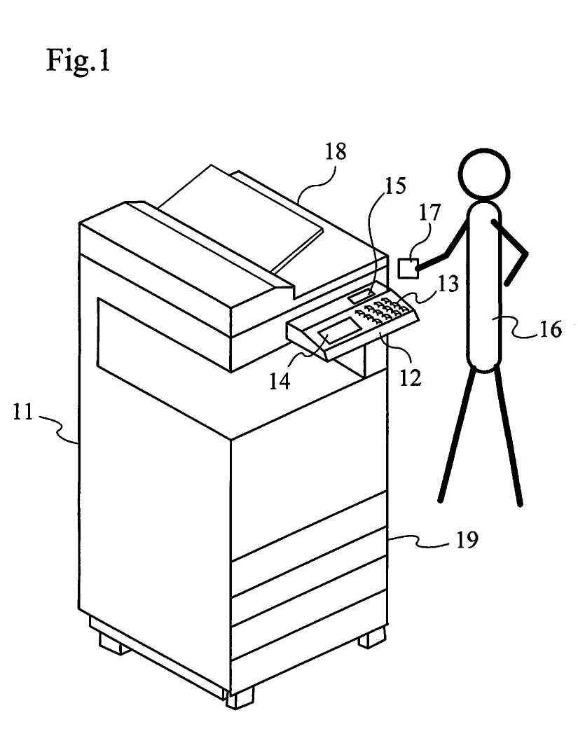

Hereinafter, an embodiment will be described with the drawings. An operation unit 12 is disposed in the upper portion of a complex-type image forming apparatus 11 shown in FIG. 1. The operation unit 12 includes various kinds of keys 13, such as a start key, numerical keys, a copy key, a scan key, a facsimile key, and a setting and registration key, to set or input operation conditions. A display unit 14 such as a liquid crystal is disposed in the vicinity of the keys 13. Further, the operation unit 12 is provided with an individual user data reading unit 15. When an ID card 17 carried by a user 16 approaches the individual user data reading unit 15 in a non-contact manner, the individual user data reading unit 15 reads user identification data or various kinds of registration data stored in the ID card 17.

The ID card 17 includes an IC chip, a radio wave transceiver unit and the like. The IC chip includes a control unit and a memory storing various kinds of data. The ID card 17 receives radio waves from the individual user data reading unit 15 installed in the operation unit 12, generates an electromotive force to the inside of the card by the radio waves, and reads various kinds of data from the memory.

A platen is installed in the upper portion of the image forming apparatus 11. An automatic document feeder 18 is openably installed on the platen. Cassettes 19 receiving sheets of various sizes are installed in the lower portion of the image forming apparatus 11.

Examples of the job functions of the image forming apparatus 11 include a printer function, a scan function, a copy function, and a FAX function, for example. The printer function is a function of printing image data or the like. The scan function includes a function of copying image data or the like read by a scanner, a function of storing the scanned image data or the like on another computer or the like, and a mail function of transmitting the read image data or the like to an external apparatus in the form of a mail. The FAX function is a function of FAX-transmitting image data or the like.

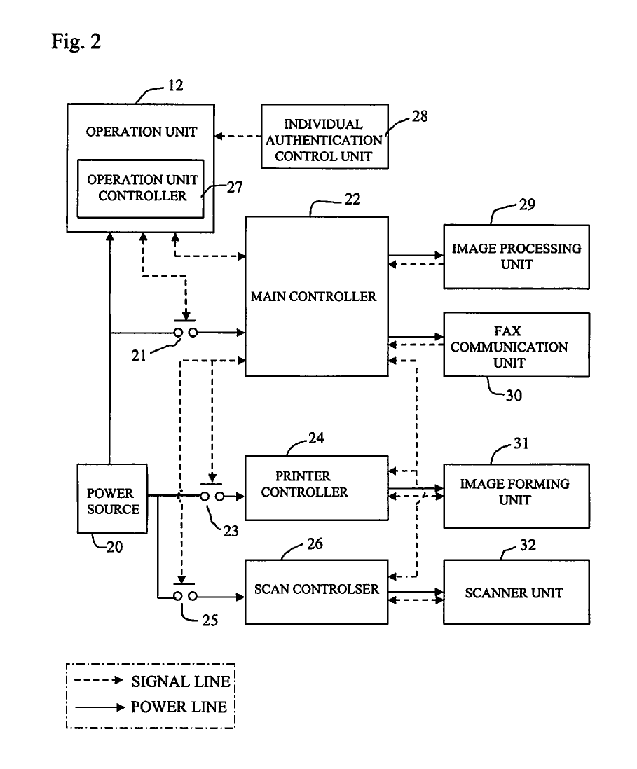

The configuration of the image forming apparatus 11 performing such functions will be described with reference to FIG. 2. In FIG. 2, a solid-line arrow indicates a power line and a dotted-line arrow indicates a signal line. The image forming apparatus 11 includes a power source 20 . The operation unit 12 is connected to the power source 20. A main controller 22 is connected to the power source 20 via a switch 21, a printer controller 24 is connected to the power source 20 via a switch 23, and a scan controller 26 is connected to the power source 20 via a switch 25.

The operation unit 12 includes an operation unit controller 27. An individual authentication control unit is connected to the operation unit 12. An image processing unit 29 and a FAX communication unit 30 are connected to the main controller 22. An image forming unit 31 is connected to the printer controller 24 and a scanner unit 32 is connected to the scan controller 26. Power is supplied from the main controller 22 to the image processing unit 29 and the FAX communication unit 30. Power is supplied from the printer controller 24 to the image forming unit 31. Power is supplied from the scan controller 26 to the scanner unit 32.

The main controller 22 exchanges a signal with the operation unit 12, the image processing unit 29, the FAX communication unit 30, the printer controller 24, and the scan controller 26. The image forming unit 31 exchanges a signal with the printer controller 24 and the scanner unit 32 exchanges a signal with the scan controller 26.

In the exemplary embodiment, the power feeding relay 21 disposed between the main controller 22 and the power source 20 is turned on or off by a signal from the operation unit 12. On the other hand, the power feeding relay 23 disposed between the printer controller 24 and the power source 20 and the power feeding relay 25 disposed between the scan controller 26 and the power source 20 are turned on or off by signals from the main controller 22. As described in detail below, the reason for controlling ON and OFF of the power supply to the printer controller 24 and the scan controller 26 using the signals from the main controller 22 is that the use priority of the plurality of functions of the complex-type image forming apparatus 11 is registered in advance.

That is, in the example of FIG. 2, when the use priority is registered in the ID card 17 carried by a user so that the use of the scan function is preferred to the use of the printer function, the power feeding relay 25 connected to the scan controller 26 is turned on while the power feeding relay 23 connected to the printer controller 24 is turned off. In this way, since no power is supplied to the printer controller 24, it is possible to suppress unnecessary power consumption.

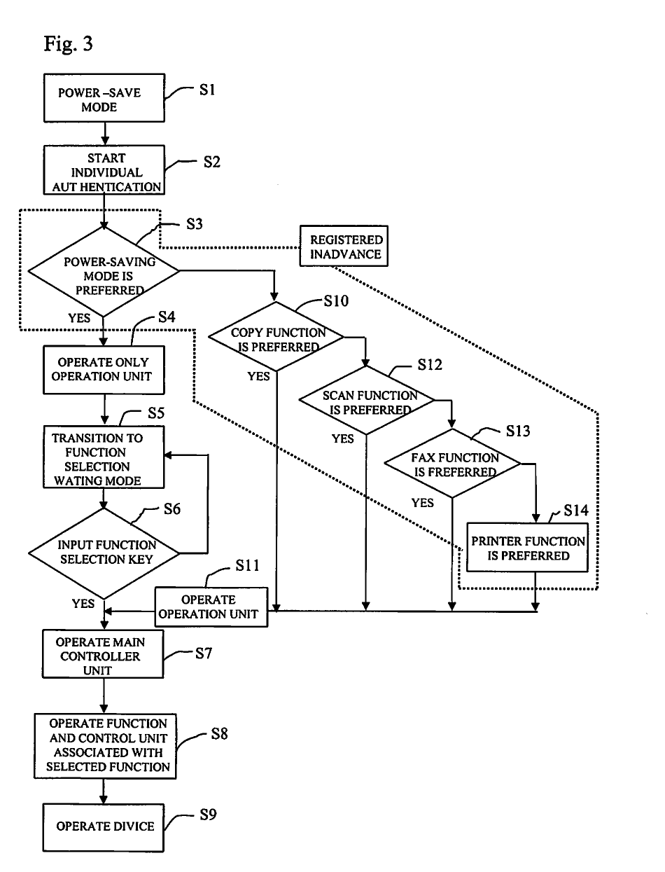

The processes according to an exemplary embodiment will be described with reference to the flowchart of FIG. 3 in addition to FIGS. 1 and 2. The image forming apparatus 11 according to an exemplary embodiment is set such that a power-saving mode is also executed (ACT 1). The power-saving mode is a mode in which only the operation unit is operated at the power start-up time of the image forming apparatus 11 and the state of the operation unit is transitioned to a function selection waiting state, as described above.

Next, individual authentication of the user 16 starts (ACT 2). In the individual authentication of the user 16, individual identification data such as the individual name, position, or the like of the user, is registered in the ID card 17 carried by the user 16. Further, as indicated by a dotted line, functions preferably used by the user are registered in the ID card 17. Examples of the registered functions include a power-saving function, a copy function, a scan function, a FAX function, and a printer function. Among these functions, the functions preferably used for each user are registered in advance in the memory of the ID card carried by each user.

As shown in FIG. 3, when the function preferably registered in the ID card of a user is the power-saving function (ACT 3), only the operation unit is operated (ACT 4). Thereafter, the state is transitioned to the function selection waiting mode (ACT 5). Then, when a desired function selection key is input from the user (ACT 6), the main controller is operated (ACT 7). Thereafter, the control unit or the like associated with the selected function is operated (ACT 8) and a device executing the selection function is operated (ACT 9).

When the function preferably registered in the ID card of a user is the copy function (ACT 10), the operation unit is operated (ACT 11) and necessary devices are operated through ACTS 7, 8, and 9 mentioned above. When the function preferably registered in the ID card of the user is the scan function (ACT 12), the FAX function (ACT 13), or the printer function (ACT 14), the above-described same function as that of the copy function (ACT 10) is executed.

In the image forming apparatus according to the exemplary embodiment, each user selects, as the preferred function, any one of the power-saving function such as a sleep mode, the copy function, the scan function, and the printer function and registers the selection function with the ID card carried by each user. For example, when the copy function is selected during the power-saving mode in the image forming apparatus 11 (ACT 10), the operation unit 12 is operated, and then the operation unit controller 27 of the operation unit 12 turns on the power feeding relay 21 connected to the main controller 22 to operate the main controller 22. Each controller and the power feeding relay connected to the function section are turned on by the operated main controller 22 and the power is fed only to the controller associated with the selected function and the function section so that the device is transitioned to a standby state.

For example, sections to which the power is fed for each function are as follows:

the copy function: the main controller 22, the scan controller 26, and the printer controller 24;

the scan function: the main controller 22 and the scan controller 26;

the FAX function: the main controller 22 and the scan controller 26; and

the printer function: the main controller 22 and the printer controller 24.

As described above, one of the power-saving function, the copy function, the scan function, the FAX function, and the printer function is registered as the function registered in the ID card of the user. However, for example, all of the copy function, the scan function, the FAX function, and the printer function may also be registered in the ID card of one user. When the ID card of the user is identified, the power is fed to the devices that execute all of the copy function, the scan function, the FAX function, and the printer function.

While certain embodiments have been described, these embodiments have been presented by way of example only, and are not and are not intended to limit the scope of the inventions. Indeed, the novel devices and methods described herein may be embodied in a variety of other forms: furthermore, various omissions, substitutions and changes in the form of the devices described herein may be made without departing from the spirit of the inventions. The accompanying claims and their equivalents are intended to cover such forms or modifications as would fall within the scope and spirit of the inventions.

What is claimed is:

1. A complex-type image forming apparatus with a plurality of functions, comprising:
a power source unit;
an operation unit that is connected to the power source unit;
a main controller that is connected to the power source unit via a power feeding relay turned on or off by a signal from the operation unit;
function controllers that are installed for the plurality of functions, respectively;
power feeding relays that are connected between the controller and the power source unit for the functions, respectively, and are turned on or off by the signal from the main controller;
an individual authentication control unit that reads user registration data, in which the function selected among the plurality of functions is registered for a user of the image forming apparatus, and is installed in the operation unit,
wherein based on the user registration data, the main controller transmits the signal for turning on the power feeding relay of the function controller for the registered function.

2. The apparatus according claim 1, wherein the user registration data is stored in an ID card carried by the user, and
wherein the individual authentication control unit includes a data reading unit that transmits data to the ID card in a non-contact manner.

3. The apparatus according to claim 1, wherein the image forming apparatus has a power-saving function of operating only the operation unit, when power is fed.

4. The apparatus according to claim 2, wherein the image forming apparatus has a power-saving function of operating only the operation unit, when power is fed.

5. The apparatus according to claim 3, wherein the plurality of functions include a copy function, a scan function, a FAX function, and a printer function.

6. The apparatus according to claim 4, wherein the plurality of functions include a copy function, a scan function, a FAX function, and a printer function.

7. The apparatus according to claim 5, wherein the function controllers include a printer controller and a scan controller.

8. The apparatus according to claim 6, wherein the function controllers include a printer controller and a scan controller.

9. The apparatus according to claim 7, wherein an image processing unit and a FAX communication unit are connected to the main controller, an image forming unit is connected to the printer controller, and a scanner unit is connected to the scan controller.

10. The apparatus according to claim 8, wherein an image processing unit and a FAX communication unit are connected to the main controller, an image forming unit is connected to the printer controller, and a scanner unit is connected to the scan controller.

11. The apparatus according to any of claim 5,
wherein when the data reading unit selects the power-saving function, only the operation unit is operated, and
wherein when one of the copy function, the scan function, the FAX function, and the printer function is selected, a device executing the selected function is operated.

12. The apparatus according to any of claim 6, wherein when the data reading unit selects the power-saving function, only the operation unit is operated, and
wherein when one of the copy function, the scan function, the FAX function, and the printer function is selected, a device executing the selected function is operated.

13. The apparatus according to any of claim 7,
wherein when the data reading unit selects the power-saving function, only the operation unit is operated, and
wherein when one of the copy function, the scan function, the FAX function, and the printer function is selected, a device executing the selected function is operated.

14. The apparatus according to any of claim 8, wherein when the data reading unit selects the power-saving function, only the operation unit is operated, and
wherein when one of the copy function, the scan function, the FAX function, and the printer function is selected, a device executing the selected function is operated.

15. The apparatus according to any of claim 9,
wherein when the data reading unit selects the power-saving function, only the operation unit is operated, and
wherein when one of the copy function, the scan function, the FAX function, and the printer function is selected, a device executing the selected function is operated.

16. The apparatus according to claim 5,
wherein when the data reading unit selects one of the copy function, the scan function, the FAX function, and the printer function, the operation unit is operated and a device executing the selected function is operated.

17. The apparatus according to claim 6,
wherein when the data reading unit selects one of the copy function, the scan function, the FAX function, and the printer function, the operation unit is operated and a device executing the selected function is operated.

18. The apparatus according to claim 8,
wherein when the data reading unit selects one of the copy function, the scan function, the FAX function, and the printer function, the operation unit is operated and a device executing the selected function is operated.

19. The apparatus according to claim 17,
wherein when the copy function is selected, the power is fed to the main controller, the scan controller, and the printer controller,
wherein when the scan function or the FAX function is selected, the power is fed to the main controller and the scan controller, and
wherein when the printer function is selected, the power is fed to the main controller and the printer controller.

20. The apparatus according to claim 18,
wherein when the copy function is selected, the power is fed to the main controller, the scan controller, and the printer controller,
wherein when the scan function or the FAX function is selected, the power is fed to the main controller and the scan controller, and
wherein when the printer function is selected, the power is fed to the main controller and the printer controller.
